(19) United States
(12) Patent Application Publication
(10) Pub. No.: US 2026/0258170 A1
(43) Pub. Date: Sep. 3, 2026

(54) CATALYST COMPONENTS FOR THE POLYMERIZATION OF OLEFINS

(71) Applicant: Basell Poliolefine Italia S.r.l., Milano (IT)

(72) Inventors: Alessandro Mignogna, Ferrara (IT); Leonardo Brustolin, Ferrara (IT); Giampiero Morini, Ferrara (IT)

(73) Assignee: Basell Poliolefine Italia S.r.l., Milano (IT)

(21) Appl. No.: 19/164,955

(22) PCT Filed: Mar. 14, 2024
(86) PCT No.: PCT/EP2024/056748

§ 371 Date: Sep. 12, 2025

(30) Foreign Application Priority Data
Mar. 17, 2023 (EP) 23162541.9

(51) Int. Cl. C08F 110/06

(52) U.S. Cl. CPC C08F 110/06

(57) ABSTRACT

A solid catalyst component for the polymerization of olefins made from or containing Mg. Ti and an electron donor of formula (I):

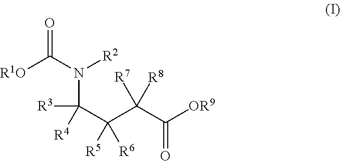

wherein R¹ and R⁹ groups. equal to or different from each other. are selected from C₁-C₁₅ hydrocarbon groups, R² group is selected from hydrogen or C₁-C₁₀ hydrocarbon groups, R³ to R⁸ groups, independently, are selected from hydrogen or C₁-C₁₅ hydrocarbon groups.

### FIELD OF THE INVENTION

In general, the present disclosure relates to the field of chemistry. More specifically, the present disclosure relates to polymer chemistry. In particular, the present disclosure relates to catalyst components for the polymerization of olefins and the catalysts obtained therefrom.

### BACKGROUND OF THE INVENTION

In some instances, catalyst components are used for the stereospecific polymerization of olefins. Concerning the polymerization of propylene, Ziegler-Natta catalysts are used which are made from or containing a solid catalyst component, constituted by a magnesium dihalide on which are supported a titanium compound and an internal electron donor compound, used in combination with an Al-alkyl compound. In some instances, an external donor is used to obtain higher crystallinity and isotacticity of the polymer. In some instances, the external donor is an alkoxysilane. In some instances, esters of phthalic acid are used as internal donors in catalyst preparations. In some instances, the ester of phthalic acid is diisobutylphthalate. In some instances, phthalates are used as internal donors in combination with alkylalkoxysilanes as external donor.

In some instances, the phthalates have raised health concerns.

### SUMMARY OF THE INVENTION

In a general embodiment, the present disclosure provides a catalyst component for the polymerization of olefins made from or containing Mg, Ti and an electron donor of formula (I):

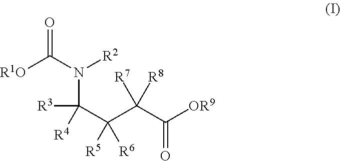

wherein R¹ and R⁹ groups, equal to or different from each other, are selected from C₁-C₁₅ hydrocarbon groups, R² group is selected from hydrogen or C₁-C₁₀ hydrocarbon groups, R³ to R⁸ groups, independently, are selected from hydrogen or C₁-C₁₅ hydrocarbon groups. In some embodiments, R³ to R⁸ groups are fused together to form one or more cycles.

### DETAILED DESCRIPTION OF THE INVENTION

In some embodiments, the groups R¹ to R⁹, independently, contain a heteroatom selected from halogen, P, S, N, O and Si.

In some embodiments, R¹ and R⁹, independently, are a C₁-C₁₀ alkyl group, alternatively a C₁-C₈ alkyl group. In some embodiments, the alkyl group is a primary alkyl group.

In some embodiments, R² is selected from C₁-C₁₀ alkyl groups, alternatively from C₂-C₁₀ alkyl groups, alternatively from C₂-C₁₀ primary alkyl groups.

In some embodiments, R³ and R⁴ are, independently, selected from hydrogen or C₁-C₁₀ alkyl group, alternatively from hydrogen or a C₁-C₈ alkyl groups, alternatively from hydrogen or linear C₁-C₈ alkyl groups. In some embodiments, both R³ and R⁴ are hydrogen.

In some embodiments, R⁵ to R⁸ are, independently, selected from hydrogen or C₁-C₂₀ hydrocarbon groups, alternatively from hydrogen or a C₁-C₁₅ hydrocarbon groups, alternatively from hydrogen or C₁-C₁₀ hydrocarbon groups.

In some embodiments, R⁶ and R⁷ are joined together to form a cyclic structure having 3-10 carbon atoms forming the ring. In some embodiments, the cyclic structure has from 5 to 6 carbon atoms forming the ring. In some embodiments, the cyclic structure bears one or more substituents on the ring selected from C₁-C₁₀ hydrocarbon groups, alternatively from C₁-C₁₀ alkyl group, alternatively from C₁-C₈ alkyl groups.

In some embodiments, R⁶ and R⁷ form a cyclic structure while R⁵ and R⁸ are hydrogen.

In some embodiments, the structures have the formula (II):

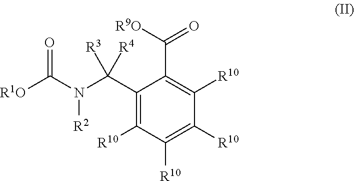

wherein R¹-R⁴ and R⁹ have the same meaning as disclosed above and R¹⁰ are, independently, selected from hydrogen, halogen or C₁-C₁₀ alkyl group, alternatively from hydrogen, halogen or a C₁-C₈ alkyl group.

In some embodiments, the structures of formula (II) are wherein R¹ and R⁹ are, independently, a C₁-C₁₀ primary alkyl group, R² is selected from C₁-C₁₀ linear or branched alkyl groups, R³ and R⁴ are selected from hydrogen or C₁-C₁₀ alkyl groups, and R¹⁰ groups are, independently, selected from hydrogen, C₁-C₈ alkyl groups or halogen, providing wherein at least two of R¹⁰ groups are hydrogen.

In some embodiments, the final amount of electron donor compound in the solid catalyst component ranges from 1 to 25% by weight, alternatively in the range from 3 to 20% by weight.

In some embodiments, compounds of formulas (I) or (II) are selected from the group consisting of methyl 4-((methoxycarbonyl)amino)butanoate, methyl 4-((methoxycarbonyl)(methyl)amino)3-methylbutanoate, methyl 4-((cyclohexylmethyl)(methoxycarbonyl)amino)3-methylbutanoate, methyl 4-(hexyl(methoxycarbonyl)amino)-3-methylpentanoate, methyl 4-(benzyl(methoxycarbonyl)amino)-3-methylpentanoate, methyl 4-(butyl(methoxycarbonyl)amino)-2,3-dimethylpentanoate, methyl 2-isopropyl-4-((methoxycarbonyl)(methyl)amino)-5-methylhexanoate, methyl 2-isopropyl-4-(hexyl(methoxycarbonyl)amino)-5-methylhexanoate, pentyl 2-isopropyl-4-((cyclohexylmethyl)(methoxycarbonyl)amino)-5-methylhexanoate, methyl 3-benzyl-4-(isopropyl(methoxycarbonyl)amino)butanoate, methyl 4-((methoxycarbonyl)(propyl)amino)-2-methyl-5-phenylpentanoate, methyl 4-((cyclohexylmethyl)(methoxycarbonyl)amino)-2-methyl-5-phenylpentanoate, ethyl 4-((methoxycarbonyl)amino)butanoate, ethyl 2-(((ethoxycarbonyl)(ethyl)amino)methyl)benzoate, ethyl 4-(hexyl(methoxycarbonyl)amino)butanoate, propyl 4-(hexyl(methoxycarbonyl)amino)3-methylbutanoate, ethyl 4-((methoxycarbonyl)amino)-3-methylpentanoate, ethyl 4-(isopropyl(methoxycarbonyl)amino)-3-methylpentanoate, hexyl 4-((methoxycarbonyl)amino)-2,3-dimethylpentanoate, ethyl 4-(isopropyl(methoxycarbonyl)amino)-2,3-dimethylpentanoate, ethyl 2-isopropyl-4-(butyl(methoxycarbonyl)amino)-5-methylhexanoate, ethyl 2-isopropyl-4-(isobutyl(methoxycarbonyl)amino)-5-methylhexanoate, ethyl 2-(((ethoxycarbonyl)(propyl)amino)methyl)benzoate, ethyl 3-benzyl-4-(cyclohexyl(methoxycarbonyl)amino)butanoate, ethyl 3-benzyl-4-(benzyl(methoxycarbonyl)amino)butanoate, decyl 4-((ethoxycarbonyl)(methyl)amino)butanoate, ethyl 4-(cyclohexyl(ethoxycarbonyl)amino)butanoate, ethyl 4-((ethoxycarbonyl)amino)3-methylbutanoate, ethyl 4-((cyclohexylmethyl)(ethoxycarbonyl)amino)3-methylbutanoate, ethyl 4-(cyclohexyl(ethoxycarbonyl)amino)-3-methylpentanoate, ethyl 4-(ethyl(ethoxycarbonyl)amino)-2,3-dimethylpentanoate, ethyl 4-(butyl(ethoxycarbonyl)amino)-2,3-dimethylpentanoate, ethyl 4-(benzyl(ethoxycarbonyl)amino)-2,3-dimethylpentanoate, ethyl 2-isopropyl-4-((2-ethylhexyl)(ethoxycarbonyl)amino)-5-methylhexanoate, ethyl 3-benzyl-4-((ethoxycarbonyl)amino)butanoate, ethyl 4-(isobutyl(ethoxycarbonyl)amino)-2-methyl-5-phenylpentanoate, isobutyl 4-(hexyl(ethoxycarbonyl)amino)butanoate, isobutyl 4-((2-ethylhexyl)(ethoxycarbonyl)amino)3-methylbutanoate, isobutyl 2-((hexyl(isobutoxycarbonyl)amino)methyl)benzoate, isobutyl 4-((ethoxycarbonyl)(propyl)amino)-3-methylpentanoate, isobutyl 4-((ethoxycarbonyl)amino)-2,3-dimethylpentanoate, isobutyl 2-isopropyl-4-(cyclohexyl(ethoxycarbonyl)amino)-5-methylhexanoate, isobutyl 3-benzyl-4-(benzyl(ethoxycarbonyl)amino)butanoate, isobutyl 4-((cyclohexylmethyl)(ethoxycarbonyl)amino)-2-methyl-5-phenylpentanoate, propyl 4-((isobutoxycarbonyl)amino)butanoate, propyl 4-((isobutoxycarbonyl)(methyl)amino)3-methylbutanoate, propyl 4-(ethyl(isobutoxycarbonyl)amino)-3-methylpentanoate, propyl 4-((isobutoxycarbonyl)(propyl)amino)-2,3-dimethylpentanoate, propyl 2-isopropyl-4-(butyl(isobutoxycarbonyl)amino)-5-methylhexanoate, propyl 3-benzyl-4-(cyclohexyl(isobutoxycarbonyl)amino)butanoate, propyl 4-((2-ethylhexyl)(isobutoxycarbonyl)amino)-2-methyl-5-phenylpentanoate, propyl 4-((cyclohexylmethyl)(isobutoxycarbonyl)amino)-2-methyl-5-phenylpentanoate, isobutyl 4-(ethyl(isobutoxycarbonyl)amino)butanoate, isobutyl 4-((2-ethylhexyl)(isobutoxycarbonyl)amino)3-methylbutanoate, isobutyl 4-(benzyl(isobutoxycarbonyl)amino)-3-methylpentanoate, isopentyl 4-((cyclohexylmethyl)(isobutoxycarbonyl)amino)-2,3-dimethylpentanoate, isobutyl 2-isopropyl-4-((isobutoxycarbonyl)amino)-5-methylhexanoate, isobutyl 2-((butyl(ethoxycarbonyl)amino)methyl)benzoate, isobutyl 3-benzyl-4-(butyl(isobutoxycarbonyl)amino)butanoate, isobutyl 4-(hexyl(isobutoxycarbonyl)amino)-2-methyl-5-phenylpentanoate, 2-ethylhexyl 4-(ethyl(butoxycarbonyl)amino)butanoate, 2-ethylhexyl 4-(butyl(butoxycarbonyl)amino)3-methylbutanoate, 2-ethylhexyl 4-(hexyl(butoxycarbonyl)amino)-3-methylpentanoate, 2-ethylhexyl 4-(cyclohexyl(butoxycarbonyl)amino)-2,3-dimethylpentanoate, 2-ethylhexyl 2-isopropyl-4-((2-ethylhexyl)(butoxycarbonyl)amino)-5-methylhexanoate, 2-ethylhexyl 3-benzyl-4-(benzyl(butoxycarbonyl)amino)butanoate, 2-ethylhexyl 4-((cyclohexylmethyl)(butoxycarbonyl)amino)-2-methyl-5-phenylpentanoate, benzyl 4-((ethoxycarbonyl)amino)butanoate, decyl 4-(ethyl(ethoxycarbonyl)amino)3-methylbutanoate, benzyl 4-(butyl(ethoxycarbonyl)amino)-3-methylpentanoate, benzyl 4-(hexyl(ethoxycarbonyl)amino)-2,3-dimethylpentanoate, ethyl 2-((butyl(ethoxycarbonyl)amino)methyl)benzoate, benzyl 2-isopropyl-4-(benzyl(ethoxycarbonyl)amino)-5-methylhexanoate, benzyl 3-benzyl-4-((2-ethylhexyl)(ethoxycarbonyl)amino)butanoate, benzyl 4-(isopropyl(ethoxycarbonyl)amino)-2-methyl-5-phenylpentanoate, benzyl 4-(cyclohexyl(ethoxycarbonyl)amino)-2-methyl-5-phenylpentanoate, methyl 2-(((methoxycarbonyl)amino)methyl)benzoate, methyl 2-((butyl(methoxycarbonyl)amino)methyl)benzoate, decyl 2-(((cyclohexylmethyl)(methoxycarbonyl)amino)methyl)benzoate, methyl 2-(1-((methoxycarbonyl)(methyl)amino)ethyl)benzoate, methyl 2-(1-(isobutyl(methoxycarbonyl)amino)ethyl)benzoate, methyl 2-(1-(benzyl(methoxycarbonyl)amino)ethyl)benzoate, methyl 2-((ethyl(methoxycarbonyl)amino)(phenyl)methyl)benzoate, methyl 2-((ethyl(methoxycarbonyl)amino)(4-chlorophenyl)methyl)benzoate, methyl 2-((cyclohexyl(methoxycarbonyl)amino)(4-chlorophenyl)methyl)benzoate, methyl 2-(((2-ethylhexyl)(methoxycarbonyl)amino)(phenyl)methyl)-5-chlorobenzoate, methyl 5-(tert-butyl)-2-(((methoxycarbonyl)(propyl)amino)(phenyl)methyl)-3-methylbenzoate, heptyl 5-(tert-butyl)-2-((isobutyl(methoxycarbonyl)amino)(phenyl)methyl)-3-methylbenzoate, ethyl 2-(((ethoxycarbonyl)(methyl)amino)methyl)benzoate, ethyl 2-((hexyl(ethoxycarbonyl)amino)methyl)benzoate, ethyl 2-(1-(ethyl(ethoxycarbonyl)amino)ethyl)benzoate, ethyl 2-(1-((cyclohexylmethyl)(ethoxycarbonyl)amino)ethyl)benzoate, ethyl 2-(((ethoxycarbonyl)amino)(phenyl)methyl)benzoate, ethyl 2-((isobutyl(ethoxycarbonyl)amino)(phenyl)methyl)benzoate, decyl 2-((isopropyl(ethoxycarbonyl)amino)(4-chlorophenyl)methyl)benzoate, ethyl 2-((butyl(ethoxycarbonyl)amino)(4-chlorophenyl)methyl)benzoate, ethyl 2-(((ethoxycarbonyl)amino)(phenyl)methyl)-5-chlorobenzoate, ethyl 2-((benzyl(ethoxycarbonyl)amino)(phenyl)methyl)-5-chlorobenzoate, ethyl 5-(tert-butyl)-2-((butyl(ethoxycarbonyl)amino)(phenyl)methyl)-3-methylbenzoate, ethyl 5-(tert-butyl)-2-(((cyclohexylmethyl)(ethoxycarbonyl)amino)(phenyl)methyl)-3-methylbenzoate, isobutyl 2-(((isobutoxycarbonyl)amino)methyl)benzoate, isobutyl 2-(1-((isobutoxycarbonyl)(methyl)amino)ethyl)benzoate, isobutyl 2-((ethyl(isobutoxycarbonyl)amino)(phenyl)methyl)benzoate, isobutyl 2-(((isobutoxycarbonyl)(propyl)amino)(4-chlorophenyl)methyl)benzoate, isobutyl 2-((isopropyl(isobutoxycarbonyl)amino)(phenyl)methyl)-5-chlorobenzoate, isobutyl 5-(tert-butyl)-2-((isobutyl(isobutoxycarbonyl)amino)(phenyl)methyl)-3-methylbenzoate, 2-ethylhexyl 2-(((ethoxycarbonyl)(propyl)amino)methyl)benzoate, ethyl 2-(((ethoxycarbonyl)(hexyl)amino)methyl)benzoate, 2-ethylhexyl 2-((hexyl(ethoxycarbonyl)amino)methyl)benzoate, 2-ethylhexyl 2-(((cyclohexylmethyl)(ethoxycarbonyl)amino)methyl)benzoate, 2-ethylhexyl 2-(1-(ethyl(ethoxycarbonyl)amino)ethyl)benzoate, 2-ethylhexyl 2-(((ethoxycarbonyl)amino)(phenyl)methyl)benzoate, isobutyl 2-(((ethoxycarbonyl)(hexyl)amino)methyl)benzoate, 2-ethylhexyl 2-((cyclohexyl(ethoxycarbonyl)amino)(phenyl)methyl)benzoate, isopentyl 2-(((ethoxycarbonyl)(propyl)amino)(4-chlorophenyl)methyl)benzoate, 2-ethylhexyl 2-((isopropyl(ethoxycarbonyl)amino)(4-chlorophenyl)methyl)benzoate, 2-ethylhexyl 2-(((2-ethylhexyl)(ethoxycarbonyl)amino)(4-chlorophenyl)methyl)benzoate, 2-ethylhexyl 2-(((ethoxycarbonyl)(methyl)amino)(phenyl)methyl)-5-chlorobenzoate, 2-ethylhexyl 2-((butyl(ethoxycarbonyl)amino)methyl)benzoate, octyl 2-((isobutyl(ethoxycarbonyl)amino)(phenyl)methyl)-5-chlorobenzoate, 2-ethylhexyl 2-((benzyl(ethoxycarbonyl)amino)(phenyl)methyl)-5-chlorobenzoate, 2-ethylhexyl 5-(tert-butyl)-2-(((ethoxycarbonyl)amino)(phenyl)methyl)-3-methylbenzoate, 2-ethylhexyl 5-(tert-butyl)-2-((hexyl(ethoxycarbonyl)amino)(phenyl)methyl)-3-methylbenzoate, ethyl 2-(((cyclohexylmethyl)(ethoxycarbonyl)amino)methyl)benzoate, 2-ethylhexyl 5-(tert-butyl)-2-(((cyclohexylmethyl)(ethoxycarbonyl)amino)(phenyl)methyl)-3-methylbenzoate, isobutyl 2-(((isobutoxycarbonyl)amino)(4-fluorophenyl)methyl)benzoate, sec-butyl 2-((isopropyl(isobutoxycarbonyl)amino)(4-fluorophenyl)methyl)benzoate, isobutyl 2-((hexyl(isobutoxycarbonyl)amino)(4-fluorophenyl)methyl)benzoate, 2-ethylhexyl 2-((ethyl(ethoxycarbonyl)amino)(phenyl)methyl)-4-bromobenzoate, isobutyl 2-(((2-ethylhexyl)(isobutoxycarbonyl)amino)methyl)benzoate, 2-ethylhexyl 2-((isobutyl(ethoxycarbonyl)amino)(phenyl)methyl)-4-bromobenzoate, 2-ethylhexyl 2-(((cyclohexylmethyl)(ethoxycarbonyl)amino)(phenyl)methyl)-4-bromobenzoate, methyl 2-(2-((methoxycarbonyl)(methyl)amino)phenyl)acetate, methyl 2-(2-(cyclohexyl(methoxycarbonyl)amino)phenyl)acetate, methyl 2-(2-((methoxycarbonyl)amino)phenyl)propanoate, ethyl 2-(((ethoxycarbonyl)(isobutyl)amino)methyl)benzoate, methyl 2-(2-(hexyl(ethoxycarbonyl)amino)phenyl)-2-methylpropanoate, methyl 2-(2-(cyclohexyl(methoxycarbonyl)amino)phenyl)-2-phenylacetate, methyl 2-(4-chlorophenyl)-2-(2-(ethyl(methoxycarbonyl)amino)phenyl)acetate, methyl 2-(5-(tert-butyl)-2-(ethyl(methoxycarbonyl)amino)-3-methylphenyl)-2-(4-chlorophenyl)acetate, ethyl 2-(2-((ethoxycarbonyl)amino)phenyl)acetate, benzyl 2-(2-(isobutyl(ethoxycarbonyl)amino)phenyl)propanoate, pentyl 2-(2-(cyclohexyl(ethoxycarbonyl)amino)phenyl)-2-methylpropanoate, ethyl 2-(2-((2-ethylhexyl)(ethoxycarbonyl)amino)phenyl)-2-phenylacetate, ethyl 2-(4-chlorophenyl)-2-(2-(benzyl(ethoxycarbonyl)amino)phenyl)acetate, ethyl 2-(5-(tert-butyl)-2-((cyclohexylmethyl)(ethoxycarbonyl)amino)-3-methylphenyl)-2-(4-chlorophenyl)acetate, isobutyl 2-(2-((isobutoxycarbonyl)(methyl)amino)phenyl)acetate, isobutyl 2-(2-(cyclohexyl(isobutoxycarbonyl)amino)phenyl)acetate, isobutyl 2-(2-(isopropyl(isobutoxycarbonyl)amino)phenyl)propanoate, isobutyl 2-(2-(hexyl(isobutoxycarbonyl)amino)phenyl)propanoate, isobutyl 2-(2-(hexyl(isobutoxycarbonyl)amino)phenyl)-2-methylpropanoate, isobutyl 2-(((ethoxycarbonyl)(2-ethylhexyl)amino)methyl)benzoate, isobutyl 2-(2-((2-ethylhexyl)(isobutoxycarbonyl)amino)phenyl)-2-methylpropanoate, isobutyl 2-(2-(benzyl(isobutoxycarbonyl)amino)phenyl)-2-phenylacetate, isobutyl 2-(2-((cyclohexylmethyl)(isobutoxycarbonyl)amino)phenyl)-2-phenylacetate, isobutyl 2-(4-chlorophenyl)-2-(2-(cyclohexyl(isobutoxycarbonyl)amino)phenyl)acetate, isobutyl 2-(5-(tert-butyl)-2-(isopropyl(isobutoxycarbonyl)amino)-3-methylphenyl)-2-(4-chlorophenyl)acetate, 2-ethylhexyl 2-(2-((butoxycarbonyl)amino)phenyl)acetate, 2-ethylhexyl 2-(2-(benzyl(butoxycarbonyl)amino)phenyl)acetate, 2-ethylhexyl 2-(2-((butoxycarbonyl)(propyl)amino)phenyl)propanoate, 2-ethylhexyl 2-(2-((2-ethylhexyl)(butoxycarbonyl)amino)phenyl)propanoate, 2-ethylhexyl 2-(2-(butyl(butoxycarbonyl)amino)phenyl)-2-methylpropanoate, 2-ethylhexyl 2-(2-((butoxycarbonyl)amino)phenyl)-2-phenylacetate, 2-ethylhexyl 2-(2-(isobutyl(butoxycarbonyl)amino)phenyl)-2-phenylacetate, 2-ethylhexyl 2-(4-chlorophenyl)-2-(2-(isopropyl(butoxycarbonyl)amino)phenyl)acetate, 2-ethylhexyl 2-(4-chlorophenyl)-2-(2-((2-ethylhexyl)(butoxycarbonyl)amino)phenyl)acetate, 2-ethylhexyl 2-(5-(tert-butyl)-2-((butoxycarbonyl)(propyl)amino)-3-methylphenyl)-2-(4-chlorophenyl)acetate, and 2-ethylhexyl 2-(5-(tert-butyl)-2-((cyclohexylmethyl)(butoxycarbonyl)amino)-3-methylphenyl)-2-(4-chlorophenyl)acetate.

In some embodiments, formula (I) compounds are prepared using the following route.

In some embodiments, an amino acid is converted to ((alkyloxy)carbonyl)amino acid with alkyl chloroformate while the acid moiety is treated in alcohol under Fischer conditions, thereby obtaining an ester. In some embodiments and in the alternative to using an amino acid, the ester is prepared from an α-aldehydo-acid or α-keto-acid precursor via reductive amination using a primary amine and a boron hydride reducing agent.

In some embodiments and in the solid catalyst component, the amount of Ti atoms is higher than 2.5% wt, alternatively higher than 3.0% wt, with respect to the total weight of the catalyst component.

In some embodiments, the catalyst components are made from or containing the electron donors, Ti, Mg and halogen. In some embodiments, the catalyst components are made from or containing a titanium compound, having at least a Ti-halogen bond, and the electron donor compounds, supported on a Mg halide. In some embodiments, the magnesium halide, alternatively MgCl₂, in active form is used as a support for Ziegler-Natta catalysts as described in U.S. Pat. Nos. 4,298,718 and 4,495,338. In some embodiments, the magnesium dihalides in active form used as support or co-support in components of catalysts for the polymerization of olefins have X-ray spectra, wherein the most intense diffraction line in the spectrum of the non-active halide is diminished in intensity and replaced by a halo having maximum intensity displaced towards lower angles relative to that of the more intense line.

In some embodiments, the titanium compounds are selected from the group consisting of TiCl₄ and TiCl₃. In some embodiments, the titanium compounds are Ti-haloalcoholates having formula Ti(OR¹¹)_{m-y}X_{y}, where m is the valence of titanium, y is a number between 1 and m−1, X is halogen and R¹¹ is a hydrocarbon radical having from 1 to 10 carbon atoms.

In some embodiments, the solid catalyst component is prepared by a reaction between magnesium alcoholates or chloroalcoholates and an excess of TiCl₄, in the presence of the electron donor compounds at a temperature of about 80 to 120° C. In some embodiments, the chloroalcoholates are prepared according to U.S. Pat. No. 4,220,554.

In some embodiments, the solid catalyst component is prepared by reacting a titanium compound of formula Ti(OR¹¹)_{m-y}X_{y}, wherein m is the valence of titanium and y is a number between 1 and m, with a magnesium chloride deriving from an adduct of formula MgCl₂·pR¹²OH, wherein p is a number between 0.1 and 6, alternatively from 2 to 3.5, and R¹² is a hydrocarbon radical having 1-18 carbon atoms. In some embodiments, the titanium compound is TiCl₄. In some embodiments, adduct is prepared in spherical form by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. In some embodiments, the procedure for the preparation of the spherical adducts is as disclosed in U.S. Pat. Nos. 4,399,054 and 4,469,648. In some embodiments, the adduct is directly reacted with Ti compound or subjected to thermal controlled dealcoholation (80-130° C.), thereby obtaining an adduct in which the number of moles of alcohol is lower than 3, alternatively between 0.1 and 2.5. In some embodiments, the reaction with the Ti compound is carried out by suspending the adduct (dealcoholated or as such) in cold TiCl₄ (about 0° C.) In some embodiments, the mixture is heated up to 80-130° C. and kept at this temperature for 0.5-2 hours. In some embodiments, the treatment with TiCl₄ is carried out one or more times. In some embodiments, the electron donor compound is added during the treatment with TiCl₄. In some embodiments, the preparation of catalyst components in spherical form occurs as described in European Patent Application Nos. EP-A-395083, EP-A-553805, EP-A-553806, and EPA601525 and Patent Cooperation Treaty Publication No. WO98/44009.

In some embodiments, the solid catalyst components show a surface area (by B.E.T. method) between 20 and 500 m²/g, alternatively between 50 and 400 m²/g, and a total porosity (by B.E.T. method) higher than 0.2 cm³/g, alternatively between 0.2 and 0.6 cm³/g. In some embodiments, the porosity (Hg method) due to pores with radius up to 10.000 Å ranges from 0.3 to 1.5 cm³/g, alternatively from 0.45 to 1 cm³/g.

In some embodiments, the solid catalyst component has an average particle size ranging from 5 to 120 μm, alternatively from 10 to 100 μm.

In some embodiments, the electron donor compounds are added as such or obtained in situ by using a precursor.

In some embodiments, the final amount of the electron donor compound provides a molar ratio with respect to the Ti atoms from 0.01 to 2, alternatively from 0.05 to 1.5.

In some embodiments, the solid catalyst components contain additional donors. In some embodiments, the additional donors are of various types. In some embodiments, the additional donors are selected from the group consisting of esters, ethers, carbamates, thioesters, amides and ketones.

In some embodiments, the 1,3-diethers have the formula (IV)

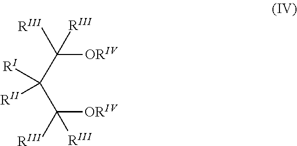

wherein R^{I} and R^{II} are the same or different and are hydrogen or linear or branched C₁-C₁₈ hydrocarbon groups; R^{III} groups, equal or different from each other, are hydrogen or C₁-C₁₈ hydrocarbon groups; R^{IV} groups, equal or different from each other, have the same meaning of R^{III} except that R^{IV} groups are not hydrogen. In some embodiments, R^{I} or R^{II} has constituents which form cyclic structures. In some embodiments, each of R^{I} to R^{IV} groups contain heteroatoms selected from the group consisting of halogens, N, O, S and Si.

In some embodiments, R^{IV} is a 1-6 carbon atom alkyl radical, alternatively a methyl. In some embodiments, the R^{III} radicals are hydrogen. In some embodiments, R^{I} is selected from the group consisting of methyl, ethyl, propyl, isopropyl, and isopentyl while R^{II} is selected from the group consisting of ethyl, propyl, isopropyl, butyl, isobutyl, tert-butyl, isopentyl, 2-ethylhexyl, cyclopentyl, cyclohexyl, methylcyclohexyl, phenyl, and benzyl. In some embodiments, R^{I} is hydrogen and R^{II} is selected from the group consisting of ethyl, butyl, sec-butyl, tert-butyl, 2-ethylhexyl, cyclohexylethyl, diphenylmethyl, p-chlorophenyl, 1-naphthyl, and 1-decahydronaphthyl. In some embodiments, R^{I} and R^{II} are the same and selected from the group consisting of ethyl, propyl, isopropyl, butyl, isobutyl, tert-butyl, neopentyl, phenyl, benzyl, cyclohexyl, cyclopentyl.

In some embodiments, the 1,3-diethers have formula (V):

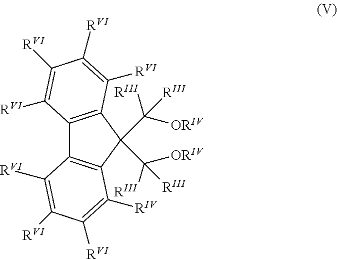

wherein the R^{VI} radicals equal or different are hydrogen; halogens; C₁-C₂₀ alkyl radicals, linear or branched; C₃-C₂₀ cycloalkyl, C₆-C₂₀ aryl, C₇-C₂₀ alkylaryl and C₇-C₂₀ arylalkyl radicals, optionally containing one or more heteroatoms selected from the group consisting of N, O, S, P, Si and halogens, as substitutes for carbon or hydrogen atoms, or both; the radicals R^{III} and R^{IV} are as defined above for formula (IV). In some embodiments, the halogens are selected from the group consisting of Cl and F.

In some embodiments, the solid catalyst components are converted into catalysts for the polymerization of olefins by reacting the components with organoaluminum compounds.

In some embodiments, the present disclosure provides a catalyst or catalyst system for the polymerization of olefins CH₂═CHIR, wherein R is hydrogen or a hydrocarbyl radical with 1-12 carbon atoms, made from or containing the product obtained by contacting:
(i) the solid catalyst component and
(ii) an alkylaluminum compound and optionally,
(iii) an external electron donor compound.

In some embodiments, the alkyl-Al compound (ii) is a trialkyl aluminum compound. In some embodiments, the trialkyl aluminum compound is selected from the group consisting of triethylaluminum, triisobutyl aluminum, tri-n-butylaluminum, tri-n-hexylaluminum, and tri-n-octylaluminum. In some embodiments, the alkyl-Al compound (ii) is selected from the group consisting of alkylaluminum halides, alkylaluminum hydrides, alkylaluminum sesquichlorides, and mixtures with tri alkyl aluminum compounds. In some embodiments, the alkylaluminum sesquichlorides are AlEt₂Cl or Al₂Et₃Cl₃.

In some embodiments, the external electron-donor compounds are selected from the group consisting of silicon compounds, ethers, esters, amines, and heterocyclic compounds.

In some embodiments, the external donor compounds are silicon compounds of formula (R¹³)ₐ(R¹⁴)_{b}Si(OR¹⁵)_{c}, where a and b are integers from 0 to 2, c is an integer from 1 to 4 and the sum (a+b+c) is 4; R¹³, R¹⁴, and R¹⁵, are radicals with 1-18 carbon atoms optionally containing heteroatoms. In some embodiments, the external donor compounds are silicon compounds wherein a is 1, b is 1, c is 2, at least one of R¹³ and R¹⁴ is selected from branched alkyl, cycloalkyl or aryl groups with 3-10 carbon atoms optionally containing heteroatoms and R¹⁵ is a C₁-C₁₀ alkyl group. In some embodiments, R¹⁵ is methyl. In some embodiments, the silicon compounds are selected from the group consisting of methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl)t-butyldimethoxysilane, (2-ethylpiperidinyl)thexyldimethoxysilane, (3,3,3-trifluoro-n-propyl)(2-ethylpiperidinyl)dimethoxysilane, methyl(3,3,3-trifluoro-n-propyl)dimethoxysilane, and N,N-diethylaminotriethoxysilane. In some embodiments, the external donor compounds are the silicon compounds wherein a is 0, c is 3, R¹⁴ is a branched alkyl or cycloalkyl group, optionally containing heteroatoms, and R¹⁵ is methyl. In some embodiments, the silicon compounds are selected from the group consisting of cyclohexyltrimethoxysilane, t-butyltrimethoxysilane and thexyltrimethoxysilane.

In some embodiments, the amount of electron donor compound (iii) provides a molar ratio between the organoaluminum compound and the electron donor compound (iii) of from 0.1 to 500, alternatively from 1 to 300, alternatively from 3 to 100.

In some embodiments, the catalyst components are used to produce polypropylene, with an activity higher than 50 kg/gcat, alternatively higher than 55 kg/gcat, and a xylene insolubility at 25° C. higher than 96.0% wt, alternatively higher than 96.5% wt, alternatively higher than 97.0% wt. In some embodiments, the catalyst components are used with an aluminum alkyl compound and an alkyl alkoxysilane.

In some embodiments, the present disclosure provides a process for the homopolymerization or copolymerization of olefins CH₂═CHR, wherein R is hydrogen or a hydrocarbyl radical with 1-12 carbon atoms, carried out in the presence of a catalyst made from or containing the product of the reaction between:
(i) the solid catalyst component;
(ii) an alkylaluminum compound and,
(iii) optionally an electron-donor compound (external donor).

In some embodiments, the polymerization process is carried out in a slurry polymerization using as diluent an inert hydrocarbon solvent, or in bulk polymerization using the liquid monomer as a reaction medium. In some embodiments, the liquid monomer is propylene. In some embodiments, the polymerization process is carried out in gas-phase operating in one or more fluidized or mechanically agitated bed reactors.

In some embodiments, the polymerization is carried out at temperature of from 20 to 120° C., alternatively of from 40 to 80° C. In some embodiments, the polymerization is carried out in gas-phase with an operating pressure between 0.5 and 5 MPa, alternatively between 1 and 4 MPa. In some embodiments, the polymerization is carried out in a bulk polymerization with the operating pressure between 1 and 8 MPa, alternatively between 1.5 and 5 MPa.

The following examples are given to illustrate the disclosure without being intended as limiting the disclosure.

### Characterizations

### Determination of X.I.

2.5 g of polymer and 250 ml of o-xylene were placed in a round-bottomed flask, provided with a cooler and a reflux condenser, and kept under nitrogen. The resulting mixture was heated to 135° C. and kept under stirring for about 60 minutes. The final solution was cooled to 25° C. under continuous stirring. The insoluble polymer was then filtered. The filtrate was evaporated in a nitrogen flow at 140° C. to reach a constant weight. The content of xylene-soluble fraction was expressed as a percentage of the original 2.5 grams and then, by difference, the X.I. %.

### Determination of Donors.

The content of electron donor was carried out via gas-chromatography. The solid component was dissolved in acidic water. The solution was extracted with ethyl acetate. An internal standard was added. A sample of the organic phase was analyzed in a gas chromatograph, thereby determining the amount of donor present at the starting catalyst compound.

### Melt Flow Rate (MFR)

The melt flow rate MIL of the polymer was determined according to ISO 1133 (230° C., 2.16 Kg).

### EXAMPLES

### Procedure for Preparation of the Spherical Adduct

An initial amount of microspheroidal MgCl₂·2.8C₂H₅OH was prepared according to the method disclosed in Example 2 of Patent Cooperation Treaty Publication No. WO98/44009, but operating on a larger scale.

### Procedure for the Polymerization of Propylene

A 4-liter steel autoclave, equipped with a stirrer, pressure gauge, thermometer, catalyst feeding system, monomer feeding lines and thermostatic jacket, was purged with nitrogen flow at 70° C. for one hour. Then, at 30° C. under propylene flow, the autoclave was charged, in sequence, with 75 mL of anhydrous hexane, 0.76 g of AlEt₃, dicyclopentyl dimethoxysilane as external electron donor, thereby providing an Al/Donor molar ratio of 20, and 0.006÷0.010 g of solid catalyst component. The autoclave was closed; subsequently 2.0 NL of hydrogen were added. Then, under stirring, 1.2 kg of liquid propylene was fed. The temperature was raised to 70° C. in five minutes. The polymerization was carried out at this temperature for two hours. At the end of the polymerization, the non-reacted propylene was removed. The polymer was recovered and dried at 70° C. under vacuum for three hours. Then, the polymer was weighed and fractionated with o-xylene to determine the amount of the xylene insoluble (X.I.) fraction.

### Procedure for the Preparation of the Internal Donors

### Example 1: ethyl 2-(((ethoxycarbonyl)(methyl)amino)methyl)benzoate

### Step 1: Synthesis of 2-((methylamino)methyl)benzoic acid

In a 250 cm³ round bottom flask, equipped with magnetic stirrer, 5.0 g (33 mmol) of 2-formylbenzoic acid were dissolved in 50 cm³ of methanol. 5.8 cm³ (66 mmol, 2 eq) aqueous methylamine (40% wt) were added dropwise at room temperature. After 1 hour, 0.7 g (18 mmol, 0.6 eq) of sodium borohydride were added in small portions at 0° C., then the reaction was left at room temperature for 3 hours. At this point, the solvent was removed under vacuum, thereby obtaining a viscous oil, which was triturated with acetone, yielding the product as a white solid. Yield 100%, ¹HNMR (400 MHz, D₂O): 2.98 (s, 3H, CH₃), 4.20 (s, 2H, CH₂), 7.2-7.7 (m, 4H, arom.).

### Step 2: Synthesis of 2-(((ethoxycarbonyl)(methyl)amino)methyl)benzoic acid

In a 250 cm³ round bottom flask, equipped with magnetic stirrer, 5.5 g (33 mmol) of 2-((methylamino)methyl)benzoic acid were dissolved in 20 cm³ of aqueous NaOH (3 eq with respect to the amino acid). Then, 5.5 g (50 mmol, 1.5 eq) of ethyl chloroformate were added dropwise. The reaction occurred, under stirring at room temperature for 3 hours. Successively, the mixture was acidified with 1M HCl, and the product was extracted with ethyl acetate. The organic fraction was washed with 2 volumes of water, then evaporated yielding the final product as a colorless oil. Yield 67%. ¹HNMR (400 MHz, CDCl₃): 1.2 (t, 3H, CH₃), 2.9 (s, 3H, CH₃), 4.1 (q, 2H, CH₂), 4.9 (s, 2H, CH₂), 7.3-7.5 (m, 3H, arom.), 7.8 (m, 1H, arom.).

### Step 3: Synthesis of ethyl 2-(((ethoxycarbonyl)(methyl)amino)methyl)benzoate

In a 250 cm³ round bottom flask, equipped with magnetic stirrer, 5.2 g (0.22 mmol) of 2-(((ethoxycarbonyl)(methyl)amino)methyl)benzoic acid were dissolved in 50 cm³ ethanol with 1 cm³ of sulfuric acid. The mixture was refluxed for 5 hours, then the solvent was removed. The raw product was dissolved in ethyl acetate and washed with aqueous sodium bicarbonate. Then, after solvent removal, the final product was obtained as a colorless oil. Yield 80%, purity 95% (GC). ¹HNMR (400 MHz, CDCl₃): 1.1 (t, 3H, CH₃), 1.2 (t, 3H, CH₃), 2.8 (s, 3H, CH₃), 4.1 (q, 2H, CH₂), 4.3 (q, 2H, CH₂), 4.8 (s, 2H, CH₂), 7.3-7.5 (m, 3H, arom.), 7.9 (m, 1H, arom.).

### Example 2: ethyl 2-(((ethoxycarbonyl)(ethyl)amino)methyl)benzoate

### Step 1: Synthesis of 2-((ethylamino)methyl)benzoic acid

This derivative was prepared according to the synthesis described in Example 1—Step 1, using ethylamine 2 M in THF instead of aqueous methylamine. Yield 90%. ¹HNMR (400 MHz, D₂O): 1.0 (t, 3H, CH₃), 2.6 (q, 2H, CH₂), 3.9 (s, 2H, CH₂), 7.2 (m, 3H, arom.), 7.7 (m, 1H, arom.).

### Step 2: Synthesis of 2-(((ethoxycarbonyl)(ethyl)amino)methyl)benzoic acid

This derivative was prepared according to the synthesis described in Example 1—Step 2, using 2-((ethylamino)methyl)benzoic acid as starting material. Yield 72%. ¹HNMR (400 MHz, CDCl₃): 1.1 (m, 6H, CH₃+CH₃), 3.3 (q, 2H, CH₂), 4.1 (q, 2H, CH₂), 4.8 (s, 2H, CH₂), 7.3-7.5 (m, 3H, arom.), 8.0 (m, 1H, arom.).

### Step 3: ethyl 2-(((ethoxycarbonyl)(ethyl)amino)methyl)benzoate

This derivative was prepared according to the synthesis described in Example 1—Step 3, using 2-(((ethoxycarbonyl)(ethyl)amino)methyl)benzoic acid as starting material. Yield 90%, purity 99% (GC). ¹HNMR (400 MHz, CDCl₃): 1.1 (m, 6H, CH₃+CH₃), 1.3 (m, 6H, CH₃), 3.2 (q, 2H, CH₂), 4.1 (q, 2H, CH₂), 4.3 (q, 2H, CH₂), 4.8 (s, 2H, CH₂), 7.3-7.5 (m, 3H, arom.), 7.9 (m, 1H, arom.).

### Example 3: ethyl 2-(((ethoxycarbonyl)(propyl)amino)methyl)benzoate

### Step 1: Synthesis of 2-((propylamino)methyl)benzoic acid

This derivative was prepared according to the synthesis described in Example 1—Step 1, using n-propylamine instead of aqueous methylamine. Yield 85%. ¹HNMR (400 MHz, D₂O): 0.8 (t, 3H, CH₃), 1.5 (m, 2H, CH₂), 3.3 (m, 2H, CH₂), 3.9 (s, 2H, CH₂), 7.2-7.7 (m, 4H, arom.).

### Step 2: Synthesis of 2-(((ethoxycarbonyl)(propyl)amino)methyl)benzoic acid

This derivative was prepared according to the synthesis described in Example 1—Step 2, using 2-((propylamino)methyl)benzoic acid as starting material. Yield 74%. ¹HNMR (400 MHz, CDCl₃): 0.8 (t, 3H, CH₃), 1.1 (m, 3H, CH₃), 1.5 (m, 2H, CH₂), 3.2 (m, 2H, CH₂), 4.1 (q, 2H, CH₂), 4.9 (s, 2H, CH₂), 7.3-7.5 (m, 3H, arom.), 8.0 (m, 1H, arom.).

### Step 3: Synthesis of ethyl 2-(((ethoxycarbonyl)(propyl)amino)methyl)benzoate

This derivative was prepared according to the synthesis described in Example 1—Step 3, using 2-(((ethoxycarbonyl)(propyl)amino)methyl)benzoic acid as starting material. Yield 84%, purity 96% (GC). ¹HNMR (400 MHz, CDCl₃): 0.8 (t, 3H, CH₃), 1.1 (m, 3H, CH₃), 1.3 (t, 3H, CH₃), 1.5 (m, 2H, CH₂), 3.1 (m, 2H, CH₂), 4.1 (m, 2H, CH₂), 4.3 (q, 2H, CH₂), 4.8 (s, 2H, CH₂), 7.2-7.5 (m, 3H, arom.), 7.9 (m, 1H, arom.).

### Example 4: ethyl 2-((butyl(ethoxycarbonyl)amino)methyl)benzoate

### Step 1: Synthesis of 2-((butylamino)methyl)benzoic acid

This derivative was prepared according to the synthesis described in Example 1—Step 1, using n-butylamine instead of aqueous methylamine. Yield 100%. ¹HNMR (400 MHz, D₂O): 0.8 (t, 3H, CH₃), 1.3 (m, 2H, CH₂), 1.5 (m, 2H, CH₂), 2.6 (m, 2H, CH₂), 3.9 (s, 2H, CH₂), 7.3 (m, 3H, arom.), 7.7 (m, 1H, arom.).

### Step 2: Synthesis of 2-((butyl(ethoxycarbonyl)amino)methyl)benzoic acid

This derivative was prepared according to the synthesis described in Example 1—Step 2, using 2-((butylamino)methyl)benzoic acid as starting material. Yield 81%. ¹HNMR (400 MHz, CDCl₃): 0.8 (t, 3H, CH₃), 1.3 (m, 5H, CH₂+CH₃), 1.5 (m, 2H, CH₂), 3.2 (m, 2H, CH₂), 4.1 (m, 2H, CH₂), 4.9 (s, 2H, CH₂), 7.3-7.5 (m, 3H, arom.), 8.0 (m, 1H, arom.).

### Step 3: Synthesis of ethyl 2-((butyl(ethoxycarbonyl)amino)methyl)benzoate

This derivative was prepared according to the synthesis described in Example 1—Step 3, using 2-((butyl(ethoxycarbonyl)amino)methyl)benzoic acid as starting material. Yield 89%, purity 95% (GC). ¹HNMR (400 MHz, CDCl₃): 0.8 (t, 3H, CH₃), 1.0-1.5 (m, 10H, 2CH₃+2CH₂), 3.1 (m, 2H, CH₂), 4.1 (m, 2H, CH₂), 4.3 (q, 2H, CH₂), 4.8 (s, 2H, CH₂), 7.2-7.5 (m, 3H, arom.), 7.9 (m, 1H, arom.).

### Example 5: isobutyl 2-((butyl(ethoxycarbonyl)amino)methyl)benzoate

### Synthesis of isobutyl 2-((butyl(ethoxycarbonyl)amino)methyl)benzoate

This derivative was prepared according to the synthesis described in Example 4—Step 3, using iso-butanol as solvent. Yield 90%, purity 97% (GC). ¹HNMR (400 MHz, CDCl₃): 0.8 (t, 3H, CH₃), 0.9 (d, 6H, 2CH₃), 1.0-1.5 (m, 7H, CH₃(CH₂)₂), 2.1 (m, 1H, CH), 3.2 (m, 2H, CH₂), 4.2 (m, 4H, 2CH₂), 4.8 (s, 2H, CH₂), 7.2-7.5 (m, 3H, arom.), 8.0 (m, 1H, arom.).

### Example 6: 2-ethylhexyl 2-((butyl(ethoxycarbonyl)amino)methyl)benzoate

### Synthesis of 2-ethylhexyl 2-((butyl(ethoxycarbonyl)amino)methyl)benzoate

This derivative was prepared according to the synthesis described in Example 4—Step 3, using 2-(2-ethylhexyloxy)ethanol as solvent. Yield 78%, purity 98% (GC). ¹HNMR (400 MHz, CDCl₃): 0.8 (m, 9H, 3CH₃), 1.1-1.7 (m, 16H, CH₃(CH₂)₂+(CH₂)₃CHCH₂), 3.2 (m, 2H, CH₂), 4.1 (m, 4H, 2CH₂), 4.8 (s, 2H, CH₂), 7.2-7.5 (m, 3H, arom.), 7.9 (m, 1H, arom.).

### Example 7: ethyl 2-(((ethoxycarbonyl)(isobutyl)amino)methyl)benzoate

### Step 1: Synthesis of 2-((isobutylamino)methyl)benzoic acid

This derivative was prepared according to the synthesis described in Example 1—Step 1, using iso-butylamine instead of aqueous methylamine. Yield 100%. T HNMR (400 MHz, D₂O): 0.8 (d, 6H, 2CH₃), 1.7 (m, 1H, CH), 2.4 (d, 2H, CH₂), 2.6 (m, 2H, CH₂), 3.8 (s, 2H, CH₂), 7.3 (m, 3H, arom.), 7.7 (m, 1H, arom.).

### Step 2: Synthesis of 2-(((ethoxycarbonyl)(isobutyl)amino)methyl)benzoic acid

This derivative was prepared according to the synthesis described in Example 1—Step 2, using 2-((isobutylamino)methyl)benzoic acid as starting material. Yield 81%. ¹HNMR (400 MHz, CDCl₃): 0.8 (d, 3H, 2CH₃), 1.1 (m, 3H, CH₃), 1.9 (m, 1H, CH), 3.1 (d, 2H, CH₂), 4.1 (m, 2H, CH₂), 4.8 (s, 2H, CH₂), 7.3-7.5 (m, 3H, arom.), 8.0 (m, 1H, arom.).

### Step 3: Synthesis of ethyl ethyl 2-(((ethoxycarbonyl)(isobutyl)amino)methyl)benzoate

This derivative was prepared according to the synthesis described in Example 1—Step 3, using 2-(((ethoxycarbonyl)(isobutyl)amino)methyl)benzoic acid as starting material. Yield 87%, purity 95% (GC). ¹HNMR (400 MHz, CDCl₃): 0.8 (d, 6H, 2CH₃), 1.0-1.3 (m, 6H, CH₃+CH₃), 1.9 (m, 1H, CH), 3.0 (m, 2H, CH₂), 4.1 (m, 2H, CH₂), 4.3 (q, 2H, CH₂), 4.8 (s, 2H, CH₂), 7.2-7.5 (m, 3H, arom.), 7.9 (m, 1H, arom.).

### Example 8: ethyl 2-(((ethoxycarbonyl)(hexyl)amino)methyl)benzoate

### Step 1: Synthesis of 2-((hexylamino)methyl)benzoic acid

This derivative was prepared according to the synthesis described in Example 1—Step 1, using n-hexylamine instead of aqueous methylamine. Yield 73%. ¹HNMR (400 MHz, D₂O): 0.7 (t, 3H, CH₃), 1.0-1.5 (m, 8H, (CH₂)₄), 2.5 (m, 2H, CH₂), 4.0 (s, 2H, CH₂), 7.0-7.3 (m, 3H, arom.), 7.8 (m, 1H, arom.).

### Step 2: Synthesis of 2-(((ethoxycarbonyl)(hexyl)amino)methyl)benzoic acid

This derivative was prepared according to the synthesis described in Example 1—Step 2, using 2-((hexylamino)methyl)benzoic acid as starting material. Yield 80%. ¹HNMR (400 MHz, CDCl₃): 0.8 (t, 3H, CH₃), 1.3 (m, 9H, (CH₂)₃+CH₃), 1.6 (m, 2H, CH₂), 3.3 (m, 2H, CH₂), 4.2 (m, 2H, CH₂), 4.9 (s, 2H, CH₂), 7.3-7.6 (m, 3H, arom.), 8.1 (m, 1H, arom.).

### Step 3: Synthesis of ethyl 2-(((ethoxycarbonyl)(hexyl)amino)methyl)benzoate

This derivative was prepared according to the synthesis described in Example 1—Step 3, using 2-(((ethoxycarbonyl)(hexyl)amino)methyl)benzoic acid as starting material. Yield 94%, purity 99% (GC). ¹HNMR (400 MHz, CDCl₃): 0.8 (t, 3H, CH₃), 1.0-1.6 (m, 14H, 2CH₃+(CH₂)₄), 3.1 (m, 2H, CH₂), 4.1 (m, 2H, CH₂), 4.3 (q, 2H, CH₂), 4.8 (s, 2H, CH₂), 7.2-7.5 (m, 3H, arom.), 7.9 (m, 1H, arom.).

### Example 9: isobutyl 2-(((ethoxycarbonyl)(hexyl)amino)methyl)benzoate

### Synthesis of isobutyl 2-(((ethoxycarbonyl)(hexyl)amino)methyl)benzoate

This derivative was prepared according to the synthesis described in Example 8—Step 3, using 2-(((ethoxycarbonyl)(hexyl)amino)methyl)benzoic acid as starting material and iso-butanol as solvent. Yield 83%, purity 94% (GC). ¹HNMR (400 MHz, CDCl₃): 0.8 (t, 3H, CH₃), 0.9 (d, 6H, 2CH₃), 1.0-1.5 (m, 8H, (CH₂)₄), 2.0 (m, 1H, CH), 3.1 (m, 2H, CH₂), 4.2 (m, 4H, 2CH₂), 4.8 (s, 2H, CH₂), 7.2-7.5 (m, 3H, arom.), 7.9 (m, 1H, arom.).

### Example 10: isobutyl 2-((hexyl(isobutoxycarbonyl)amino)methyl)

### Step 1: Synthesis of 2-((hexyl(isobutoxycarbonyl)amino)methyl)benzoic acid

This derivative was prepared according to the synthesis described in Example 8—Step 2, using 2-((hexylamino)methyl)benzoic acid as starting material and iso-butyl chloroformate as alkylating agent. Yield 60%. ¹HNMR (400 MHz, CDCl₃): 0.8-0.9 (m, 9H, CH₃₊₂CH₃), 1.2-1.6 (m, 8H, (CH₂)₄), 1.9 (m, 1H, CH), 3.1 (m, 2H, CH₂), 4.2 (m, 2H, CH₂), 4.9 (s, 2H, CH₂), 7.3-7.6 (m, 3H, arom.), 8.0 (m, 1H, arom.).

### Step 2: Synthesis of isobutyl 2-((hexyl(isobutoxycarbonyl)amino)methyl)benzoate

This derivative was prepared according to the synthesis described in Example 9, using 2-((hexyl(isobutoxycarbonyl)amino)methyl)benzoic acid as starting material. Yield 93%, purity 97% (GC). ¹HNMR (400 MHz, CDCl₃): 0.7-1.0 (m, 12H, 2CH₃+2CH₃), 1.1-1.6 (m, 8H, (CH₂)₄), 1.8 (m, 1H, CH), 2.0 (m, 1H, CH), 3.1 (m, 2H, CH₂), 3.8 (m, 2H, CH₂), 4.0 (d, 2H, CH₂), 4.8 (s, 2H, CH₂), 7.2-7.5 (m, 3H, arom.), 7.9 (m, 1H, arom.).

### Example 11: ethyl 2-(((ethoxycarbonyl)(2-ethylhexyl)amino)methyl)benzoate

### Step 1: Synthesis of 2-(((2-ethylhexyl)amino)methyl)benzoic acid

This derivative was prepared according to the synthesis described in Example 1—Step 1, using (2-ethyl)hexylamine instead of aqueous methylamine. Yield 50%. ¹HNMR (400 MHz, D₂O): 0.6-0.9 (m, 6H, CH₃+CH₃), 1.0-1.4 (m, 7H, CH(CH₂)₃), 1.5 (m, 2H, CH₂), 2.7 (m, 2H, CH₂), 4.1 (m, 2H, CH₂), 7.0-7.4 (m, 3H, arom.), 8 (m, 1H, arom.).

### Step 2: Synthesis of 2-(((ethoxycarbonyl)(2-ethylhexyl)amino)methyl)benzoic acid

This derivative was prepared according to the synthesis described in Example 1—Step 2, using 2-(((2-ethylhexyl)amino)methyl)benzoic acid as starting material. Yield 75%. ¹HNMR (400 MHz, CDCl₃): 0.7 (m, 6H, CH₃+CH₃), 1.0-1.4 (m, 10H, CH(CH₂)₃+CH₃), 1.6 (m, 2H, CH₂), 3.2 (m, 2H, CH₂), 4.1 (m, 2H, CH₂), 4.8 (s, 2H, CH₂), 7.2-7.5 (m, 3H, arom.), 8.0 (m, 1H, arom.).

### Step 3: Synthesis of ethyl 2-(((ethoxycarbonyl)(2-ethylhexyl)amino)methyl)benzoate

This derivative was prepared according to the synthesis described in Example 1—Step 3, using 2-(((ethoxycarbonyl)(2-ethylhexyl)amino)methyl)benzoic acid as starting material. Yield 90%, purity 99% (GC). ¹HNMR (400 MHz, CDCl₃): 0.7 (m, 6H, CH₃+CH₃), 1.0-1.4 (m, 13H, CH(CH₂)₃+2CH₃), 1.6 (m, 2H, CH₂), 3.1 (m, 2H, CH₂), 4.1 (m, 2H, CH₂), 4.3 (q, 2H, CH₂), 4.9 (s, 2H, CH₂), 7.1-7.4 (m, 3H, arom.), 7.9 (m, 1H, arom.).

### Example 12: isobutyl 2-(((ethoxycarbonyl)(2-ethylhexyl)amino)methyl)benzoate

### Synthesis of isobutyl 2-(((ethoxycarbonyl)(2-ethylhexyl)amino)methyl)benzoate

This derivative was prepared according to the synthesis described in Example 11—Step 3, using iso-butanol as solvent. Yield 92%, purity 98% (GC). ¹HNMR (400 MHz, CDCl₃): 0.7 (m, 6H, CH₃+CH₃), 0.9 (d, 6H, (CH₃)₂), 1.0-1.6 (m, 12H, (CH₂)₃CHCH₂CH₃), 2.0 (m, 1H, CH), 3.1 (m, 2H, CH₂), 4.1 (m, 4H, 2CH₂), 4.9 (m, 2H, CH₂), 7.1-7.4 (m, 3H, arom.), 7.9 (m, 1H, arom.).

### Example 13: isobutyl 2-(((2-ethylhexyl)(isobutoxycarbonyl)amino)methyl)benzoate

### Step 1: Synthesis of 2-(((2-ethylhexyl)(isobutoxycarbonyl)amino)methyl)benzoic acid

This derivative was prepared according to the synthesis described in Example 10—Step 1, using 2-(((2-ethylhexyl)amino)methyl)benzoic acid as starting material. Yield 84%. ¹HNMR (400 MHz, CDCl₃): 0.8-1.0 (m, 9H, CH₃+(CH₃)₂), 1.0-1.6 (m, 12H, (CH₂)₃CHCH₂CH₃), 3.1 (m, 2H, CH₂), 3.8 (m, 2H, CH₂), 4.8 (s, 2H, CH₂), 7.2-7.5 (m, 3H, arom.), 8.0 (m, 1H, arom.).

### Step 3: Synthesis of isobutyl 2-(((2-ethylhexyl)(isobutoxycarbonyl)amino)methyl)benzoate

This derivative was prepared according to the synthesis described in Example 12, using 2-(((2-ethylhexyl)(isobutoxycarbonyl)amino)methyl)benzoic acid as starting material. Yield 95%, purity 97% (GC). ¹HNMR (400 MHz, CDCl₃): 0.6 (m, 3H, CH₃), 0.7 (m, 6H, (CH₃)₂), 0.9 (m, 6H, (CH₃)₂), 1.0-1.7 (m, 12H, (CH₂)₃CHCH₂CH₃), 2.0 (m, 2H, 2CH), 3.1 (m, 2H, CH₂), 3.8 (m, 2H, CH₂), 4.1 (m, 2H, CH₂), 4.9 (m, 2H, CH₂), 7.2-7.5 (m, 3H, arom.), 7.9 (m, 1H, arom.).

### Example 14: ethyl 2-(((cyclohexylmethyl)(ethoxycarbonyl)amino)methyl)benzoate

### Step 1: Synthesis of 2-(((cyclohexylmethyl)amino)methyl)benzoic acid

This derivative was prepared according to the synthesis described in Example 1—Step 1, using N-methylcyclohexylamine instead of aqueous methylamine. Yield 100%. ¹HNMR (400 MHz, D₂O): 0.8-1.4 (m, 5H, cyclohexyl), 1.6 (m, 5H, cyclohexyl), 2.2 (m, 1H, CH), 3.1 (d, 2H, CH₂), 4.2 (m, 2H, CH₂), 7.0-7.4 (m, 3H, arom.), 8 (m, 1H, arom.).

### Step 2: Synthesis of 2-(((cyclohexylmethyl)(ethoxycarbonyl)amino)methyl)benzoic acid

This derivative was prepared according to the synthesis described in Example 1—Step 2, using 22-(((cyclohexylmethyl)amino)methyl)benzoic acid as starting material. Yield 80%. ¹HNMR (400 MHz, CDCl₃): 0.8-1.4 (m, 8H, cyclohexyl+CH₃), 1.6 (m, 5H, cyclohexyl), 2.1 (m, 1H, CH), 3.2 (d, 2H, CH₂), 4.0 (m, 2H, CH₂), 4.9 (s, 2H, CH₂), 7.2-7.5 (m, 3H, arom.), 7.9 (m, 1H, arom.).

### Step 3: Synthesis of ethyl 2-(((cyclohexylmethyl)(ethoxycarbonyl)amino)methyl)benzoate

This derivative was prepared according to the synthesis described in Example 1—Step 3, using 2-(((cyclohexylmethyl)(ethoxycarbonyl)amino)methyl)benzoic acid as starting material. The final raw material was subjected to purification via gel chromatography. Yield 40%, purity 95% (GC). ¹HNMR (400 MHz, CDCl₃): 0.7-1.4 (m, 8H, cyclohexyl+CH₃), 1.6 (m, H, cyclohexyl+CH₃), 1.9 (m, 1H, CH), 3.0 (m, 2H, CH₂), 4.0 (m, 2H, CH₂), 4.3 (q, 2H, CH₂), 4.9 (s, 2H, CH₂), 7.2-7.5 (m, 3H, arom.), 7.9 (m, 1H, arom.).

### Comparative Example 1: ethyl 2-((ethoxycarbonyl)(methyl)amino)benzoate

### Step 1: Synthesis of ethyl 2-((ethoxycarbonyl)amino)benzoate

In a 250 cm³ round bottom flask, equipped with magnetic stirrer, 5.0 g (30 mmol) of ethyl 2-aminobenzoate were dissolved in 50 cm³ of tetrahydrofuran along with 5.1 cm³ (36 mmol, 1.2 eq) of triethylamine. Successively, 3.5 cm³ (36 mmol, 1.2 eq) of ethyl chloroformate were added dropwise at 0° C. The reaction was left at room temperature for 3 hours. Then, the mixture was acidified with 1M HCl. The product was extracted with ethyl acetate. The organic fraction was washed with 2 volumes of water, then evaporated yielding the final product as a colorless oil. Yield 90%. ¹HNMR (400 MHz, CDCl₃): 1.2 (t, 3H, CH₃), 1.3 (t, 3H, CH₃), 4.1 (q, 2H, CH₂), 4.3 (q, 2H, CH₃), 7.3 (m, 1H, arom.), 7.6 (m, 2H, arom.), 8.1 (m, 1H, arom.).

### Step 2: Synthesis of ethyl 2-((ethoxycarbonyl)(methyl)amino)benzoate

In a 250 cm³ round bottom flask, equipped with magnetic stirrer under nitrogen atmosphere, 6.0 g (25 mmol) of ethyl 2-((ethoxycarbonyl)amino)benzoate were dissolved in 50 cm³ of tetrahydrofuran and 0.8 g (30 mmol, 1.2 eq) of sodium hydride (powder, 90%) were added in small portions. The mixture was set at 30° C. and 1.9 cm³ (30 mmol, 1.2 eq) of methyl iodide were added dropwise. The reaction occurred under stirring at 40° C. for 3 hours. Successively, the mixture was acidified with 1M HCl. The product was extracted with ethyl acetate. The organic fraction was washed with 2 volumes of water, then evaporated yielding the final product as a colorless oil. Yield 85%, purity 98%. ¹HNMR (400 MHz, CDCl₃): 1.2 (t, 3H, CH₃), 1.3 (t, 3H, CH₃), 3.3 (s, 3H, CH₃), 4.1 (q, 2H, CH₂), 4.3 (q, 2H, CH₃), 7.3 (m, 1H, arom.), 7.8-8.2 (m, 3H, arom.).

### Procedure for the Preparation of the Solid Catalyst Component

Into a 500 cm³ round bottom flask, equipped with mechanical stirrer, cooler and thermometer, 250 cm³ of TiCl₄ were introduced at room temperature under nitrogen atmosphere. After cooling to 0° C., while stirring, the internal donor listed in Table 1 and 10.0 g of the spherical adduct were sequentially added into the flask. The amount of charged internal donor provided a Mg/donor molar ratio of 6. The temperature was raised to 100° C. and maintained for 2 hours. Thereafter, stirring was stopped. The solid product settled. The supernatant liquid was siphoned off at 100° C. After the supernatant was removed, additional fresh TiCl₄ was added to reach the initial liquid volume again. The mixture was then heated at 120° C. and kept at this temperature for 1 hour. Stirring was stopped again. The solid settled. The supernatant liquid was siphoned off. The solid was washed with anhydrous hexane six times (6×100 cm³) in temperature gradient down to 60° C. and one time (100 cm³) at room temperature. The solid was then dried under vacuum. The solid catalyst components were tested in polymerization of propylene. The results are listed in Table 1.

### Examples 1-14 and Comparative Example 1

### Preparation of Solid Catalyst Component and Polymerization

The procedure for the preparation of the solid catalyst component was carried out using the donors reported in Table 1 as internal donor. The solid catalyst components were tested in polymerization of propylene. The results are listed in Table 1.

TABLE 1

| | Catalyst composition | | | | Polymerization | | |
|---|---|---|---|---|---|---|---|
| | Internal Donor | | | Ti | Activity | XI | MIL |
| Ex | Name | Structure | % wt | % wt | kg/g | % wt | g/10′ |
| I1 | ethyl 2- (((ethoxycarbonyl)(methyl)amino) methyl)benzoate | 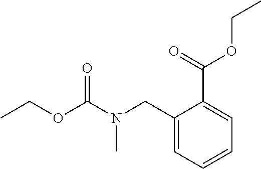 [SMILES: CCOC(=O)c1ccccc1CN(C)C(=O)OCC] | 12.1 | 3.5 | 64.4 | 97.5 | 3.9 |
| I2 | ethyl 2- (((ethoxycarbonyl)(ethyl)amino) methyl)benzoate | 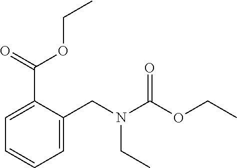 [SMILES: CCOC(=O)c1ccccc1CN(CC)C(=O)OCC] | 14.1 | 3.4 | 63.1 | 97.5 | 3.5 |
| I3 | ethyl 2- (((ethoxycarbonyl)(propyl)amino) methyl)benzoate | 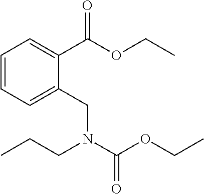 [SMILES: CCCN(Cc1ccccc1C(=O)OCC)C(=O)OCC] | 13.9 | 3.4 | 72.2 | 97.5 | 2.9 |
| I4 | ethyl 2- ((butyl(ethoxycarbonyl)amino) methyl)benzoate | 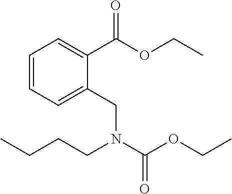 [SMILES: CCCCN(Cc1ccccc1C(=O)OCC)C(=O)OCC] | 16.4 | 3.5 | 71.5 | 97.4 | 4.0 |
| I5 | isobutyl 2- ((butyl(ethoxycarbonyl)amino) methyl)benzoate | 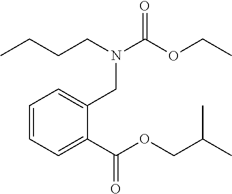 [SMILES: CCCCN(Cc1ccccc1C(=O)OCC(C)C)C(=O)OCC] | 16.1 | 3.6 | 86.1 | 97.4 | 3.8 |
| I6 | 2-ethylhexyl 2- ((butyl(ethoxycarbonyl)amino) methyl)benzoate | 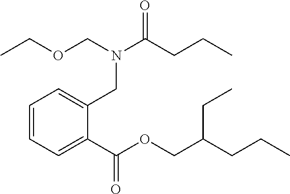 [SMILES: CCCC(=O)N(COCC)Cc1ccccc1C(=O)OCC(CC)CCC] | 19.1 | 4.0 | 83.2 | 97.0 | 4.4 |
| I7 | ethyl 2- (((ethoxycarbonyl)(isobutyl)amino) methyl)benzoate | 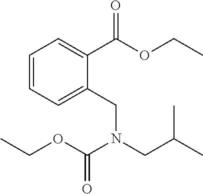 [SMILES: CCOC(=O)c1ccccc1CN(CC(C)C)C(=O)OCC] | 15.7 | 3.4 | 79.3 | 97.0 | 3.4 |
| I8 | ethyl 2- (((ethoxycarbonyl)(hexyl)amino) methyl)benzoate | 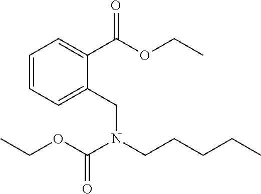 [SMILES: CCCCCN(Cc1ccccc1C(=O)OCC)C(=O)OCC] | 17.6 | 3.8 | 80.9 | 97.4 | 6.1 |
| I9 | isobutyl 2- (((ethoxycarbonyl)(hexyl)amino) methyl)benzoate | 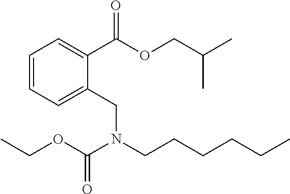 [SMILES: CCCCCCN(Cc1ccccc1C(=O)OCC(C)C)C(=O)OCC] | 16.8 | 3.5 | 91.1 | 97.6 | 3.6 |
| I10 | isobutyl 2- ((hexyl(isobutoxycarbonyl)amino) methyl)benzoate | 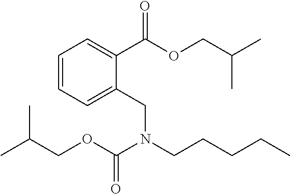 [SMILES: CCCCCN(Cc1ccccc1C(=O)OCC(C)C)C(=O)OCC(C)C] | 19.1 | 3.9 | 56.5 | 96.6 | 8.7 |
| I11 | ethyl 2-(((ethoxycarbonyl)(2- ethylhexyl)amino)methyl)benzoate | 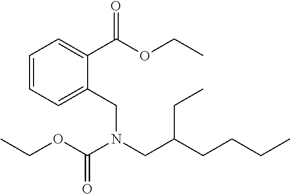 [SMILES: CCCCC(CC)CN(Cc1ccccc1C(=O)OCC)C(=O)OCC] | 19.0 | 3.8 | 79.9 | 97.6 | 3.3 |
| I12 | isobutyl 2-(((ethoxycarbonyl)(2- ethylhexyl)amino)methyl)benzoate | 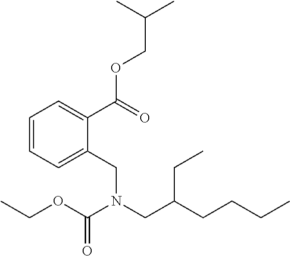 [SMILES: CCCCC(CC)CN(Cc1ccccc1C(=O)OCC(C)C)C(=O)OCC] | 19.6 | 3.9 | 75.1 | 97.4 | 3.2 |
| I13 | isobutyl 2-(((2- ethylhexyl)(isobutoxycarbonyl) amino)methyl)benzoate | 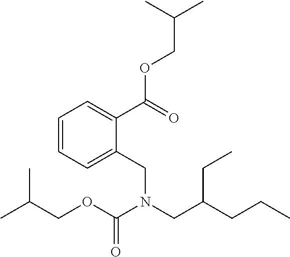 [SMILES: CCCC(CC)CN(Cc1ccccc1C(=O)OCC(C)C)C(=O)OCC(C)C] | 20.3 | 4.1 | 64.9 | 96.7 | 4.3 |
| I14 | ethyl 2- (((cyclohexylmethyl)(ethoxycarbonyl) amino)methyl)benzoate | 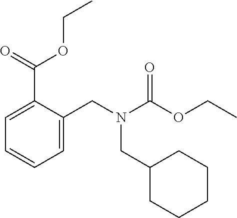 [SMILES: CCOC(=O)c1ccccc1CN(CC1CCCCC1)C(=O)OCC] | 17.6 | 3.8 | 71.8 | 97.4 | 3.9 |
| C1 | ethyl 2- ((ethoxycarbonyl)(methyl)amino) benzoate | 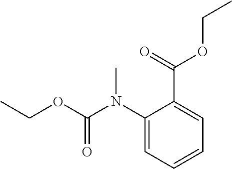 [SMILES: CCOC(=O)c1ccccc1N(C)C(=O)OCC] | nd | 4.1 | 15.7 | 91.0 | 11.2 |

nd: not determined

What is claimed is:

1. A catalyst component for the polymerization of olefins comprising Mg, Ti and an electron donor of formula (I): 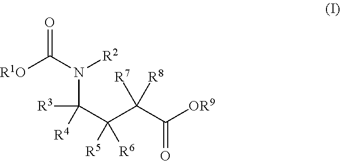
wherein R¹ and R⁹ groups, equal to or different from each other, are selected from C₁-C₁₅ hydrocarbon groups, R² group is selected from hydrogen or C₁-C₁₀ hydrocarbon groups, R³ to R⁸ groups, independently, are selected from hydrogen or C₁-C₁₅ hydrocarbon groups.

2. The catalyst component according to claim 1, wherein R¹ to R⁹, independently, contain a heteroatom selected from halogen, P, S, N, O and Si.

3. The catalyst component according to claim 1, wherein R¹ and R⁹, independently, are a C₁-C₁₀ alkyl group.

4. The catalyst component according to claim 1, wherein R² is selected from C₁-C₁₀ alkyl groups.

5. The catalyst component according to claim 1, wherein R³ and R⁴ are, independently, selected from hydrogen or C₁-C₁₀ alkyl group.

6. The catalyst component according to claim 5, wherein both R³ and R⁴ are hydrogen.

7. The catalyst component according to claim 1, wherein R⁵ to R⁸ are, independently, selected from hydrogen or C₁-C₂₀ hydrocarbon groups.

8. The catalyst component according to claim 7, wherein R⁵ to R⁸ are, independently, selected from hydrogen or a C₁-C₁₅ hydrocarbon group.

9. The catalyst component according to claim 7, wherein R⁶ and R⁷ are joined together to form a cyclic structure having 3-10 carbon atoms forming the ring.

10. The catalyst component according to claim 9, wherein R⁵ and R⁸ are both hydrogen.

11. The catalyst component according to claim 1, wherein the electron donor has the formula (II): 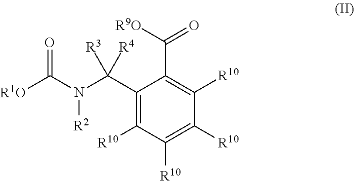
wherein R¹-R⁴ and R⁹ have the same meaning as in claim 1 and R¹⁰ are, independently, selected from hydrogen, halogen or C₁-C₁₀ alkyl group.

12. The catalyst component according to claim 11, wherein R¹ and R⁹ area independently, a C₁-C₁₀ primary alkyl group, R² is selected from C₁-C₁₀ linear or branched alkyl groups, R³ and R⁴ are selected from hydrogen or C₁-C₁₀ alkyl groups and R¹⁰ groups area, independently, selected from hydrogen, C₁-C₈ alkyl groups or halogen, providing wherein at least two of R¹⁰ groups are hydrogen.

13. A catalyst system for the polymerization of olefins comprising the product of the reaction between:
(i) the solid catalyst component according to claim 1 and
(ii) an alkylaluminum compound.

14. The catalyst system according to claim 13 further comprising an external electron donor compound.

15. A process for the homopolymerization or copolymerization of olefins CH2=CHR, wherein R is hydrogen or a hydrocarbyl radical with 1-12 carbon atoms carried out in the presence of a catalyst system according to claim 13.
